(19) United States
(12) Patent Application Publication
(10) Pub. No.: US 2005/0264584 A1
(43) Pub. Date: Dec. 1, 2005

(54) [METHOD FOR FAST INPUT OF CHINESE CHARACTER]

(76) Inventors: Zhu-Min Di, Shanghai (CN); Tony Tsai, Taipei (TW); David Ho, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/709,764

(22) Filed: May 27, 2004

(51) Int. Cl. G06K 9/18

(52) U.S. Cl. 345/636

(57) ABSTRACT

A method for rapidly inputting a Chinese character in a mobile phone is provided. The method comprises: entering into a Chinese text editing status and receiving an input code; displaying a plurality of choices of the Chinese characters corresponding to the input code, the plurality of the choices of the Chinese characters being arranged in an order based on a usage frequency of each of the plurality of choices of the Chinese characters; selecting one Chinese character from the plurality of choices of the Chinese characters; and adjusting the usage frequency of the selected Chinese character. The method utilizes a data structure with a weighting value for each Chinese character so that during the input process, the usage frequency of each character is recorded. Hence, the method can expedite the users selection of the Chinese character with a higher usage frequency to attune to the users personal habit.

### BACKGROUND OF INVENTION

1. Field of the Invention

This invention generally relates to a method for fast input of Chinese characters in a mobile phone, and more particularly to a method for fast input of Chinese characters in a mobile phone based on the users personal habit and style.

2. Description of Related Art

Recently, the use of mobile phones becomes more common. Almost everyone owns a mobile phone. When sending short messages, establishing the address books, and recording calendar events, it is required to input the Chinese characters (especially in areas where Chinese is the official language). The input method editor (IME) for Chinese characters is limited by the size of the mobile phone screen and the size of the keyboard. If the user wants to input Chinese characters rapidly, the frequency of pressing the keys needs to be reduced to allow the user to input more characters.

FIG. 1 is the flow chart for inputting Chinese characters by selecting Chinese character from a fixed candidate character list according to the prior art. Typically, when inputting a Chinese character in a mobile phone, the process flow as shown in flow chart in FIG. 1 is widely used. In step S10, the user presses the keys to input the phonetic codes to the mobile phone. In step S12, possible choices of Chinese characters corresponding to the phonetic codes are searched and displayed as a list on the screen so that in step S14, the user can select the right character from the list of Chinese characters as the input Chinese character.

The Chinese characters of the above list of Chinese characters are arranged in an order based on the frequency of usage. The more frequent the character is used, the more leading its position will be on the list. Hence, the user can find the most frequently used characters first. However, the order of the characters is fixed when the mobile phone is manufactured. The design of the Chinese character inputting system does not take into the considerations of the different users habit and style, the different cultural backgrounds and the different dialects. Hence, for some users, the most frequently used characters are listed at the bottom of the list so that the user has to go through several pages before finding the character of his choice, which is inconvenient to the user.

### SUMMARY OF INVENTION

At least one object of the present invention is to provide a method for rapidly inputting Chinese character based on the users personal habit and style, and the frequency of the usage of specific characters to resolve the issue resulting from the list of fixed choices of Chinese characters as in the prior art.

The present invention provides a method for rapidly inputting a Chinese character in a mobile phone. The method includes: entering into a Chinese text editing status and receiving an input code; displaying a plurality of choices of Chinese characters that correspond to the input code, the plurality of choices of Chinese characters being arranged in an order based on the frequency of usage of each of the choices of Chinese characters; a user selecting one Chinese character from the plurality of choices of Chinese characters; and adjusting the usage frequency of the selected Chinese character.

In one embodiment of the present invention, the step of displaying a plurality of choices of Chinese characters corresponding to the input code includes: searching for the plurality of choices of Chinese characters and the order of the plurality of choices of Chinese characters based on the input code; examining a plurality of weighting values, each of the plurality of the weighting values corresponding to the usage frequency of one of the plurality of the choices of the Chinese characters; determining whether to adjust the order of the plurality of choices of the Chinese characters based on the plurality of the weighting values; adjusting the weighting value of any one of the adjusted Chinese characters when determining to adjust the order of the plurality of the choices of the Chinese characters; and displaying the plurality of the choices of the Chinese characters based on the order of the plurality of the choices of the Chinese characters.

In one embodiment of the present invention, the step of determining whether to adjust the order of the plurality of choices of Chinese characters based on the plurality of the weighting values includes adjusting the choices of Chinese characters corresponding to the weighting value when any one of the plurality of weighting values reaches a predetermined value, and moving the predetermined value ahead to a predetermined position in the displaced list of Chinese characters.

In an embodiment of the present invention, the step of adjusting the weighting value of any one of the adjusted Chinese characters includes adding 1 to the weighting value of any one of the adjusted Chinese characters. When one of the plurality of weighting values reaches a maximum value, the plurality of the weighting values of the plurality of the choices of the Chinese characters is reset to an initial value of 1.

The present invention utilizes a data structure with a weighting value for each Chinese character so that during the input process, the usage frequency of each character is recorded. When the usage frequency reaches a certain level, the corresponding character is moved ahead in the list of choices of Chinese characters so as to expedite the selection of this particular character. Consequently, mobile phones are “smarter” to attune to the user's personal style and needs.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF DRAWINGS

FIG. 1 is a flow chart illustrating the process flow for inputting Chinese characters by selecting the Chinese character from a fixed list of characters of choice according to the prior art.

FIG. 2 is a block diagram illustrating a basic structure of a mobile phone having the function for a fast input of Chinese characters in accordance with one embodiment of the present invention.

FIG. 3 is the simplified flow chart illustrating the process flow for a fast input of the Chinese character in accordance with a preferred embodiment of the present invention.

FIG. 4 is the detailed flow chart illustrating the process flow for a fast input of the Chinese character in accordance with one embodiment of the present invention.

### DETAILED DESCRIPTION

FIG. 2 is the block diagram illustrating a basic structure of a mobile phone having the function for a fast input of Chinese characters in accordance with one embodiment of the present invention. Referring to FIG. 2, the mobile phone 20 includes a keyboard 21, a memory 22, a control unit 23, and a screen 28.

The keyboard 21 is for the mobile phone to receive a command. In this embodiment, the keyboard 21 is for receiving an input code, such as a phonetic code in order to locate a list of choices of Chinese characters. The database 24, the memory A 25 and the memory B 26 are a portion of the memory 20 of the mobile phone 20. In this embodiment, to facilitate the illustration of the present invention, the memory 20 is divided into the database 24, the memory A 25 and the memory B 26. The Chinese characters stored in the database 24 are searched based on the input code and a list of the corresponding possible choices of Chinese characters are located and listed.

The memory A 25 records the usage frequency of each Chinese character stored in the database 24 in the mobile phone. The usage frequency is so-called the weighting value. In one embodiment of the present invention, the mobile phone 20 is assumed to use the Unicode as the internal code for the Chinese characters. The internal code ranges from 0×4e00 to 0×9fff. The memory A 25 is divided into (0×9fff-0×4e00) blocks. Each memory block corresponds to the weighting value of each Chinese character. The initial value of the weighting value is “1”. When the weighting value of the Chinese character reaches a predetermined value, this Chinese character is moved a predetermined number of column ahead in the list of the choices of Chinese characters, wherein the column has a specific numbers of Chinese characters. In this embodiment, the Chinese character is moved one column ahead. In this embodiment, when the weighting value reaches a maximum value, the weighting values of all choices of the Chinese characters are reset to the initial value “1” in order to recalculate the weighting values of all choices of the Chinese characters.

The memory B 26 records the weighting values of the various choices of Chinese characters from the database 24 and the list of the choices of Chinese characters. When the weighting value of any one of the choices of Chinese characters reaches the predetermined value, the control unit 23 will adjust the order of the choices of Chinese characters recorded in the memory B26. In this embodiment, the function of the control unit 23 is to determine whether to adjust the order of the choices of Chinese characters based on the weighting values.

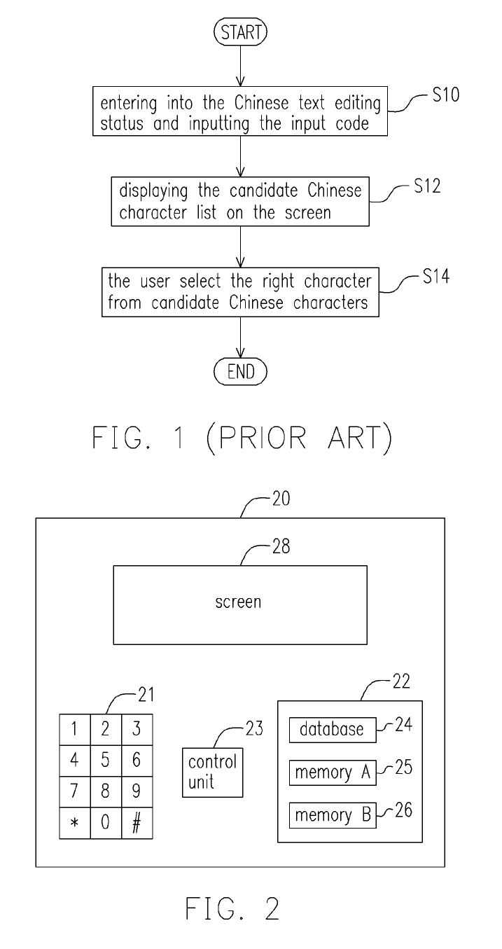

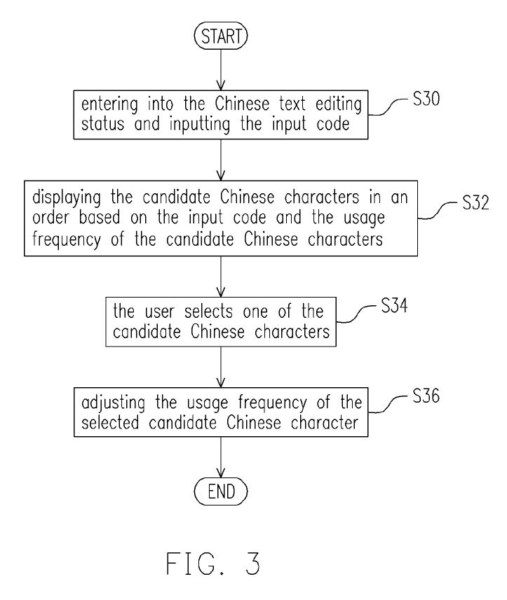

FIG. 3 is the simplified flow chart illustrating the process flow for a rapid input of a Chinese character in accordance with one embodiment of the present invention. Referring to FIGS. 1 and 3, in step S30, the mobile phone 20 enters into a Chinese text editing status and the user inputs an input code via the keyboard 21. In step S32, possible choices of Chinese characters and the order of these Chinese characters are searched based on the input code. The usage frequency of these choices of Chinese characters is also identified. The control unit 23 then determines the order of these choices of Chinese characters based on the usage frequency and displays these choices of Chinese characters in order on the screen. In step S34, the user selects from one of the choices of the Chinese characters. In step S36, the usage frequency of the selected Chinese character is adjusted. The following paragraphs further describe the process flow for a rapid input of a Chinese character in greater details.

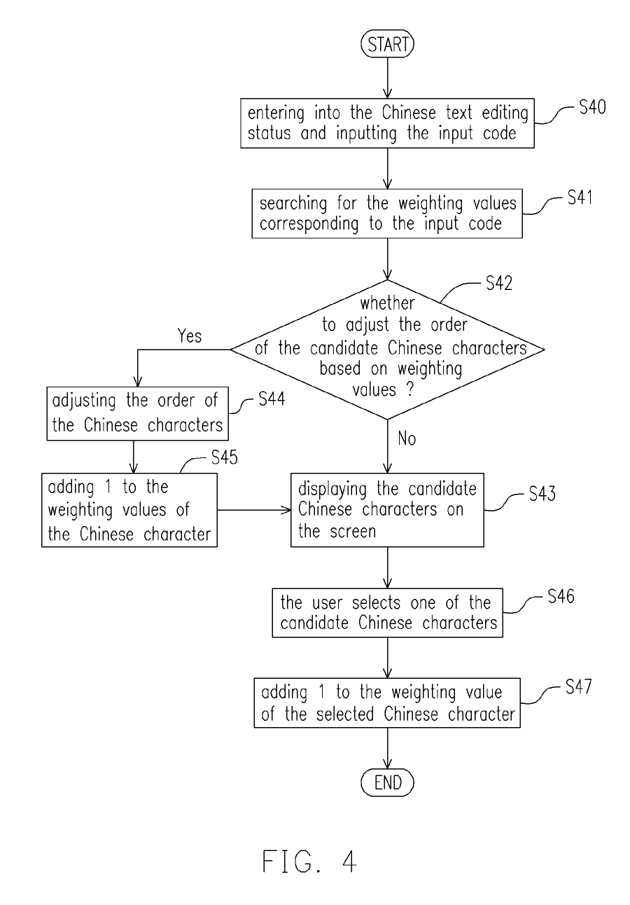

FIG. 4 is the detailed flow chart illustrating the process flow for a rapid input of the Chinese character in accordance with an embodiment of the present invention. Referring to FIGS. 1 and 4, in step S40, the mobile phone 20 enters into a Chinese text editing status and the user inputs an input code via the keyboard 21.

In step 41, the database 22 is searched for the choices of Chinese characters and the order of these Chinese characters based on the input code and this order is sent to the memory B 26. The weight values of these choices of Chinese characters are also located from the memory A 25 and are sent to memory B 26. In step S42, the control unit 23 uses the weight values recorded in the memory B 26 to determine whether to adjust the order of the choices of Chinese characters. If neither of all weighting values reaches the predetermined value, then the process goes to the step S43. Step S43 will be described in the following paragraph. If one of the weighting values reaches the predetermined value, step S24 is conducted. In step S24, the particular choice of Chinese character corresponding to the weighting value is moved one column ahead in the order of the displaced list of Chinese characters. The list of the Chinese characteristic with the order adjusted is stored again in the memory B 26 or the database 24 to facilitate the users rapid selection of Chinese characters. In step S45, the value 1 is added to the weighting value so that it is not unnecessary to adjust the order of the list next time. Thereafter, the process continues to step S43 to display the list of choices of Chinese characters for the user to select.

When the user selects one of the choices of Chinese characters (S46), the usage frequency of the selected Chinese character is adjusted in step S47, i.e., adding 1 to the weighting value of the selected Chinese character, and then storing the weighting value in the memory A 25 as a reference to determine whether to adjust the order next time.

For example, in the step S40, assuming that when the user uses the Chinese IME of the mobile phone 20 to input the phonetic code, the IME arranges the choices of Chinese characters in an order as follows (ten characters are used as an example and Cx is used to represent the Chinese characters for illustration purpose): “C1, C2, C3, C4, C5, C6, C7, C8, C9, C10”. The internal codes of these Chinese characters will be stored in the memory B 26. In step 41, the weighting values of these choices of Chinese characters are obtained from the memory A 25 as “2056, 1986, 1658, 1489, 1378, 1298, 1250, 1016, 950, 818” and these weighting values are stored in the memory B 26.

Assuming that when the weighting value reaches a multiple of the predetermined value 50, the Chinese character corresponding to the weighting value will be moved one column ahead in the order of the list of the Chinese characters. Hence, in the step S42, the remainders of the above weighting values after those weighting values being divided by 50 are “6, 36, 8, 39, 28, 48, 0, 16, 0, 18”. When the remainder is “0”, it means that the weighting value reaches the predetermined value and the corresponding Chinese character should be moved ahead. Hence, the order of the list of these Chinese characters is adjusted.

In the step S44, the control unit 23 adjusts the order of the Chinese characters stored in the memory B 26 to “C1, C2, C3, C4, C5, C7, C6, C9, C8, C10”. The characters C7 and C9 are moved one column ahead. In step S45, the weighting values of the Chinese characters C7 and C9 are increased by 1. Hence, the adjusted weighting values become “2056, 1986, 1658, 1489, 1378, 1298, 1251, 1016, 951, 818”. The adjusted weighting values of the Chinese characters C7 and C9 will not be divisible by the predetermined value 50 and will not be adjusted next time.

In step S43, the list of the choices of Chinese characters stored in the memory B 26 is displaced on the screen to facilitate the users selection. When the user selects one of the Chinese characters in the list in step S46, one is added to the weighting value of the selected Chinese character in step S47. The weighting value is then stored in the memory A 25. The usage frequency of the user is recorded for used subsequently to determine whether the order of the list of Chinese characters needs to be adjusted.

In light of the above, the present invention utilizes the data structure with a weighting value for each Chinese character so that during the input process, the usage frequency of each character is recorded. When the usage frequency reaches a certain level, the corresponding character is moved ahead in the list of the choices of Chinese characters so as to facilitate the users selection. The present invention thus allows mobile phones to be “smarter” to attune to the user's personal needs and style.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

1. A method for a fast input of a Chinese character in a mobile phone, comprising:
entering into a Chinese text editing status and receiving an input code;
displaying a plurality of choices of Chinese characters corresponding to the input code, the plurality of the choices of the Chinese characters being arranged in a list in an order based on a usage frequency of each of the plurality of the choices of the Chinese characters;
selecting one Chinese character from the plurality of the choices of the Chinese characters by a user; and
adjusting the usage frequency of the selected Chinese character.

2. The method of claim 1, wherein the step of displaying the plurality of the choices of the Chinese characters corresponding to the input code includes:
searching for the plurality of the choices of the Chinese characters and the order of the plurality of the choices of the Chinese characters based on the input code;
examining a plurality of weighting values, each of the plurality of the weighting values corresponding to the usage frequency of one of the plurality of the choices of the Chinese characters;
determining whether to adjust the order of said the list of the plurality of the choices of the Chinese characters based on the plurality of the weighting values;
adjusting the weighting value of any one of the choices of the Chinese characters with the order being adjusted when determining whether to adjust the order of the plurality of the choices of the Chinese characters; and
displaying the plurality of the choices of the Chinese characters based on the order of the plurality of the choices of the Chinese characters.

3. The method of claim 2, wherein the step of determining whether to adjust the order of the plurality of the choices of the Chinese characters based on the plurality of the weighting values includes when any one of the plurality of the weighting values reaches a predetermined value, adjusting the Chinese character corresponding to the weighting value reaching the predetermined value ahead to a predetermined position in the order.

4. The method of claim 2, wherein the step of adjusting the weighting value of any one of the choices of the Chinese characters comprises adding 1 to the weighting value of any one of the choices of the Chinese characters that is adjusted.

5. The method of claim 4 further comprising resetting the plurality of the weighting values of the plurality of the choices of the Chinese characters to an initial value 1 when one of the plurality of the weighting values reaches a maximum value.

6. The method of claim 2, wherein an initial value of the plurality of the weighting values is 1.

7. The method of claim 1, wherein the step of adjusting the usage frequency of the selected Chinese character comprises adjusting the weighting value corresponding to the selected Chinese character.

8. A method for rapidly inputting a Chinese character to a mobile phone, the mobile has a memory, the memory recording a plurality of weighting values corresponding to a plurality of Chinese characters, the method comprising:
entering into a Chinese text editing status and inputting an input code by a user;
displaying a plurality of choices of Chinese characters corresponding to the input code, the plurality of the choices of the Chinese characters being arranged in an adjusted order, the adjusted order being adjusted based on the plurality of the weighting values;
the user selecting one Chinese character from the plurality of the choices of the Chinese characters; and
adjusting the usage frequency of the selected Chinese character.

9. The method of claim 8, wherein the step of the adjusted order being adjusted based on the plurality of the weighting values comprises:
obtaining an order of the plurality of the choices of the Chinese characters based on the input code;
determining whether to adjust the order of the plurality of the choices of the Chinese characters based on the plurality of the weighting values;
adjusting the weighting value of any one of choices of the Chinese characters that has the order adjusted when determining whether to adjust the order of the plurality of the choices of the Chinese characters; and
displaying the plurality of the choices of the Chinese characters based on the adjusted order of the plurality of the choices of the Chinese characters.

10. The method of claim 9, wherein the step of adjusting the weighting value of any one of the choices of the Chinese characters that has the order adjusted comprises adjusting the choices of the Chinese characters corresponding to the weighting value reaching the predetermined value ahead to a predetermined position in the order.

11. The method of claim 9, wherein the step of determining whether to adjust the order of the plurality of the choices of the Chinese characters based on the plurality of the weighting values comprises when any one of the plurality of the weighting values reaches a predetermined value, adjusting the choices of the Chinese character corresponding to the weighting value reaching the predetermined value ahead to a predetermined position in the order.

12. The method of claim 11, wherein the step of adjusting the weighting value of any one of the choices of the Chinese characters that has the order adjusted comprises adding 1 to the weighting value of any one of the choices of the Chinese characters that has the order adjusted.

13. The method of claim 11, wherein an initial value of the plurality of weighting values is 1.

14. The method of claim 11 further comprising resetting the plurality of the weighting values of the plurality of choices of the Chinese characters to an initial value 1 when one of the plurality of the weighting values reaches a maximum value.
